(19) United States
(12) Patent Application Publication
(10) Pub. No.: US 2022/0156740 A1
(43) Pub. Date: May 19, 2022

(54) Location Analysis and Service Selection Platform for Dynamic Interface Generation and Event Processing

(71) Applicant: Bank of America Corporation, Charlotte, NC (US)

(72) Inventors: Robert Nyeland Huggins, Charlotte, NC (US); Lee Cody, Oakland, CA (US); Stephanie Rose Pritchard, Santa Monica, CA (US); Brian Prezgay, Charlotte, NC (US); Nicholas Durwood Williams, Charlotte, NC (US); Matthew M. Choiniere, Charlotte, NC (US)

(21) Appl. No.: 17/099,998

(22) Filed: Nov. 17, 2020

(51) Int. Cl. G06Q 20/40; G06Q 20/10; G06Q 20/32; G06Q 40/02

(52) U.S. Cl. CPC G06Q 20/40; G06Q 40/02; G06Q 20/322; G06Q 20/10

(57) ABSTRACT

Aspects of the disclosure relate to location analysis and service selection. A computing platform may receive goal information and detect location information. Based on the goal information and the location information, the computing platform may select an operational mode for the user device, which may be a travel mode, a shopping mode, or a financial mode. Based on the selected mode, the computing platform may generate a reprioritized interface for a mobile banking application and commands directing the user device to display the reprioritized interface, which may be an updated version of a mobile banking interface that displays information specific to the selected mode upon launch of the mobile banking application. The computing platform may send, to the user device, the reprioritized interface and the commands directing the user device to display the reprioritized interface, which may cause the user device to display the reprioritized interface.

### BACKGROUND

Aspects of the disclosure relate to mobile applications and event processing. In particular, one or more aspects of the disclosure relate to location analysis and service selection for mobile applications.

In some cases, individuals may use applications, such as a mobile banking application, to maintain and review their finances (e.g., account balances, or other financial information) while on the go. Although individuals may typically seek particular information (e.g., account balances, or other financial information) from such applications, they may, in some instances, prefer to view other information. Accordingly, by offering a static interface, these applications may cause users to experience difficulties in accessing atypical information, which may result in a negative customer experience.

Additionally or alternatively, individuals may maintain digital wallets that include a plurality of payment methods. In some instances, each payment method (e.g., credit card, debit card, and/or other methods) may provide a different set of rewards (e.g., points, cash back, and/or other rewards). However, individuals may be unaware of which payment method may result in the largest reward if used in a particular location or with a particular vendor. Accordingly, such individuals may use a payment method in a particular location that does not maximize their rewards, which may result in client side inefficiencies.

### SUMMARY

Aspects of the disclosure provide effective, efficient, scalable, and convenient technical solutions that address and overcome the technical problems associated with static application interfaces, payment selection, and/or touchless offer activation. In accordance with one or more embodiments of the disclosure, a computing platform comprising at least one processor, a communication interface, and memory storing computer-readable instructions may receive goal information indicating one or more user goals. The computing platform may monitor a user device to detect location information indicating a location of the user device. Based on the goal information and the location information, the computing platform may select an operational mode for the user device, which may be one or more of: a travel mode, a shopping mode, or a financial mode. Based on the selected mode, the computing platform may generate a reprioritized interface for a mobile banking application and one or more commands directing the user device to display the reprioritized interface, which may be an updated version of a mobile banking interface that displays information specific to the selected mode upon launch of the mobile banking application. The computing platform may send, to the user device, the reprioritized interface and the one or more commands directing the user device to display the reprioritized interface, which may cause the user device to display the reprioritized interface.

In one or more instances, the computing platform may receive a payment selection request from a user device. The computing platform may generate payment selection information based on the selected mode and the location information. Based on the payment selection information, the computing platform may generate one or more payment selection commands directing the user device to cause selection of a particular payment method. The computing platform may send, to the user device, the one or more payment selection commands directing the user device to cause selection of the particular payment method, which may cause the user device to select the particular payment method.

In one or more instances, the one or more payment selection commands directing the user device to cause selection of the particular payment method may configure the user device to apply one of a plurality of payment cards (e.g., credit cards) from an electronic wallet to complete a transaction. In one or more instances, the user device may apply the one of the plurality of payments cards (e.g., credit cards) from the electronic wallet by communicating, with a payment card reader (e.g., a credit card reader), in a touchless manner.

In one or more instances, the one or more payment selection commands directing the user device to cause selection of the particular payment method may cause the user device to display a graphical user interface indicating that one of a plurality of credit cards should be used. In one or more instances, the computing platform may identify that one or more tasks should be performed. The computing platform may generate one or more commands directing an enterprise computing infrastructure to initiate performance of the one or more tasks. The computing platform may send the one or more commands directing the enterprise computing infrastructure to initiate performance of the one or more tasks to the enterprise computing infrastructure, which may cause the enterprise computing infrastructure to initiate performance of the one or more tasks.

In one or more instances, the computing platform may identify that the one or more tasks should be performed based on one or more of: user input requesting that the one or more tasks be performed, the location information, or the selected mode. In one or more instances, the one or more tasks may include one or more of: identifying one or more promotional offers, locking a credit card, providing assistance with a foreign transaction, locating an automated teller machine (ATM), replacing a lost credit card, providing travel insights, providing a wait time for a financial center, providing available services for the financial center, indicating a particular financial center to attend, or performing a check in at the financial center.

In one or more instances, performing the check in at the financial center may include 1) detecting, based on the location information, that the user device is within a predetermined proximity of the financial center, and 2) based on detecting that the user device is within the predetermined proximity of the financial center, performing an automated check in for a user of the user device at the financial center. In one or more instances, performing the check in at the financial center may include 1) detecting, based on the location information, that the user device is within a predetermined proximity of the financial center, and 2) based on detecting that the user device is within the predetermined proximity of the financial center, causing the user device to display a check in alert, where selection of the check in alert on the user device causes performance of an automated check in for a user of the user device at the financial center.

In one or more instances, the one or more user goals may be reprioritized for display in the updated version of the mobile banking interface based on the selected mode and the location information. In one or more instances, the updated version of the mobile banking interface may be displayed while the mobile banking interface is operating in the selected mode, and the mobile banking interface may be restored to an original state once the selected mode is exited.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for implementing location analysis and service selection for dynamic interface generation and event processing in accordance with one or more example embodiments;

FIGS. 2A-2G depict an illustrative event sequence for implementing location analysis and service selection for dynamic interface generation and event processing in accordance with one or more example embodiments;

FIG. 3 depicts an illustrative method for implementing location analysis and service selection for dynamic interface generation and event processing in accordance with one or more example embodiments; and

FIGS. 4-6 depict illustrative graphical user interfaces that implement location analysis and service selection for dynamic interface generation and event processing in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances, other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief introduction to the concepts described further herein, one or more aspects of the disclosure describe dynamic location based interface generation and event processing. For example, mobile banking applications may be able to switch into different modes as a mobile device owner moves in and out of key locations such as home, shopping areas, bank-owned/operated properties, travel locations, and/or other locations. By defining geofences around points of interest (such as financial centers and partner merchants) and allowing clients to define their own (such as home and work), mobile banking experiences may be enhanced. With regard to a shopping mode, the mobile application may detect a client's presence in a grocery store and may automatically update the user interface to track the client's grocery budget, available bank-provided offers and coupons, a best credit card for the location, and/or other information related to shopping at the grocery store. With regard to the travel mode, the mobile user interface may automatically update to prioritize display of third-party content (e.g., profiles, reviews, and/or other information related to various travel destinations), available bank-provided offers and coupons, automated teller machine (ATM) locations, and/or other content that may be relevant to an individual while traveling. With regard to the financial center mode, a mobile user interface may automatically update to present location-specific information (hours, wait time, associate availability, and/or other branch specific information) and functions that may be applicable only in a bank-owned property environment (e.g., appointment check-in and/or authentication).

In some instances, one or more of the systems and methods described herein may use a client's physical location (e.g., detected using geolocation data), to automatically recommend a form of payment most preferable to the client (e.g., cash rewards credit card at a grocery, premium rewards credit card at a tourism location, digital debit at an ATM, and/or other payment selection matches). In some instances, an order of card preference may be established based on, for example, optimal card rewards structure, a rewards status, a selected cash-back category for a particular card, and/or other credit card criteria.

In some instances, one or more of the systems and methods described herein may use near-field communication (NFC), in combination with beacon technology, to present personalized offers on a nearby ATM. In these instances, consumers may hold a mobile application or touchless credit card near the NFC reader to authenticate the user and transmit the offer to their profile. In some instances, for a prospective client, a token may be transmitted to their device that may enable creation of a profile, add the offer to a cart, and allow the individual to apply and fulfill the offer automatically.

In doing so, one or more of the systems and methods described herein may provide technical solutions to address technical problems associated with mobile banking applications and payment selection. For example, rather than presenting a static user interface regardless of user location, the interface may be modified based on a user's location according to an automatically selected mode. Additionally, by analyzing benefits corresponding to a plurality of credit cards stored in an electronic wallet, a card may be automatically selected for payment so as to maximize customer rewards. This may reduce or avoid sub-optimal usage of various payment methods by customers, and enhance customer experiences.

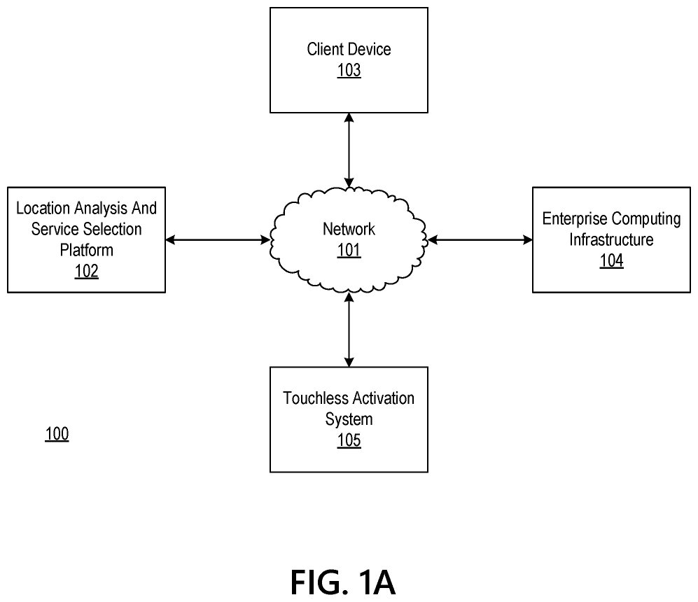

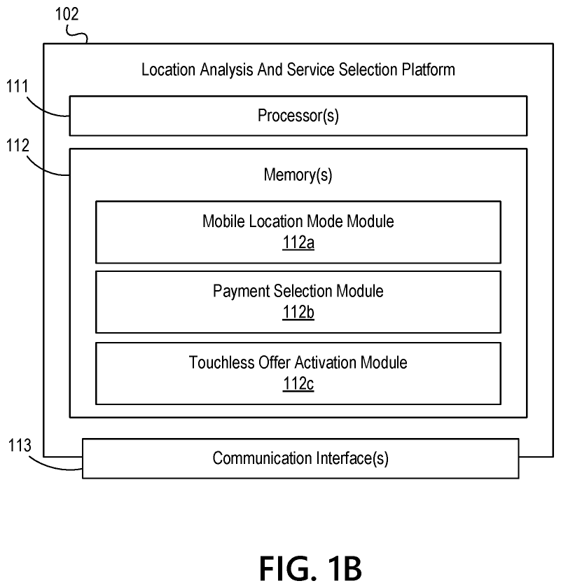

FIGS. 1A-1B depict an illustrative computing environment that implements location analysis and service selection for dynamic interface generation and event processing in accordance with one or more example embodiments. Referring to FIG. 1A, computing environment 100 may include one or more computer systems. For example, computing environment 100 may include a location analysis and service selection platform 102, client device 103, enterprise computing infrastructure 104, and touchless activation system 105.

As described further below, location analysis and service selection platform 102 may be a computer system that includes one or more computing devices (e.g., servers, server blades, or the like) and/or other computer components (e.g., processors, memories, communication interfaces) that may be used to identify user locations and cause service mode selection, payment selection, and/or touchless activation accordingly.

Client device 103 may be a laptop computer, desktop computer, mobile device, tablet, smartphone, or the like that may be used by an individual such as a client of an enterprise organization (e.g., a financial institution, or the like). For example, the client device 103 may be used by one or more individuals to access one or more applications, such as a mobile banking application. In some instances, the client device 103 may be configured with one or more location sensors (e.g., global positioning system (GPS) or other location detection sensors) that may be used to identify a location corresponding to the client device 103. In some instances, client device 103 may be configured to display one or more user interfaces (e.g., interfaces corresponding to a mobile banking application operating in one or more selected modes).

Enterprise computing infrastructure 104 may be a computer system that includes one or more computing devices (e.g., servers, server blades, laptop computers, desktop computers, mobile devices, tablets, smartphones, credit card readers, or the like) and/or other computer components (e.g., processors, memories, communication interfaces) that may be used to perform enterprise operations and/or event processing in response to commands received from the location analysis and service selection platform 102. For example, the enterprise computing infrastructure 104 may be configured to perform one or more tasks including identifying one or more promotional offers, locking a credit card, providing assistance with a foreign transaction, locating an automated teller machine (ATM), replacing a lost credit card, providing travel insights, providing a wait time for a financial center, providing available services for the financial center, indicating a particular financial center to attend, or processing a check in at the financial center. In some instances, the enterprise computing infrastructure may correspond to an enterprise organization (e.g., a grocery store, a financial institution, a travel destination, and/or other organization).

Touchless activation system 105 may be a computer system that includes one or more computing devices, such as an ATM, that is configured to activate an offer or a promotion for a user based on a determination that the user is within a predetermined distance of the ATM. In these instances, the touchless activation system 105 may be configured to activate the offer or promotion on the client device 103 in a touchless manner.

Computing environment 100 also may include one or more networks, which may interconnect location analysis and service selection platform 102, client device 103, enterprise computing infrastructure 104, and/or touchless activation system 105. For example, computing environment 100 may include a network 101 (which may interconnect, e.g., location analysis and service selection platform 102, client device 103, enterprise computing infrastructure 104, and/or touchless activation system 105).

In one or more arrangements, location analysis and service selection platform 102, client device 103, enterprise computing infrastructure 104, and/or touchless activation system 105 may be any type of computing device capable of sending and/or receiving requests and processing the requests accordingly. For example, location analysis and service selection platform 102, client device 103, enterprise computing infrastructure 104, touchless activation system 105, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of location analysis and service selection platform 102, client device 103, enterprise computing infrastructure 104, touchless activation system 105, may, in some instances, be special-purpose computing devices configured to perform specific functions.

Referring to FIG. 1B, location analysis and service selection platform 102 may include one or more processors 111, memory 112, and communication interface 113. A data bus may interconnect processor 111, memory 112, and communication interface 113. Communication interface 113 may be a network interface configured to support communication between location analysis and service selection platform 102 and one or more networks (e.g., network 101, or the like). Memory 112 may include one or more program modules having instructions that when executed by processor 111 cause location analysis and service selection platform 102 to perform one or more functions described herein and/or one or more databases that may store and/or otherwise maintain information which may be used by such program modules and/or processor 111. In some instances, the one or more program modules and/or databases may be stored by and/or maintained in different memory units of location analysis and service selection platform 102 and/or by different computing devices that may form and/or otherwise make up location analysis and service selection platform 102. For example, memory 112 may have, host, store, and/or include mobile location mode module 112a, payment selection module 112b, and touchless offer activation module 112c.

Mobile location mode module 112a may have instructions that direct and/or cause location analysis and service selection platform 102 to execute advanced techniques to select application modes based on location and goal information. Payment selection module 112b may have instructions that direct and/or cause location analysis and service selection platform 102 to execute advanced techniques to select a payment method based on location information and a selected mode. Touchless offer activation module 112c may have instructions that direct and/or cause location analysis and service selection platform 102 to execute advanced techniques to cause offers to be activated in a touchless manner at the client device 103.

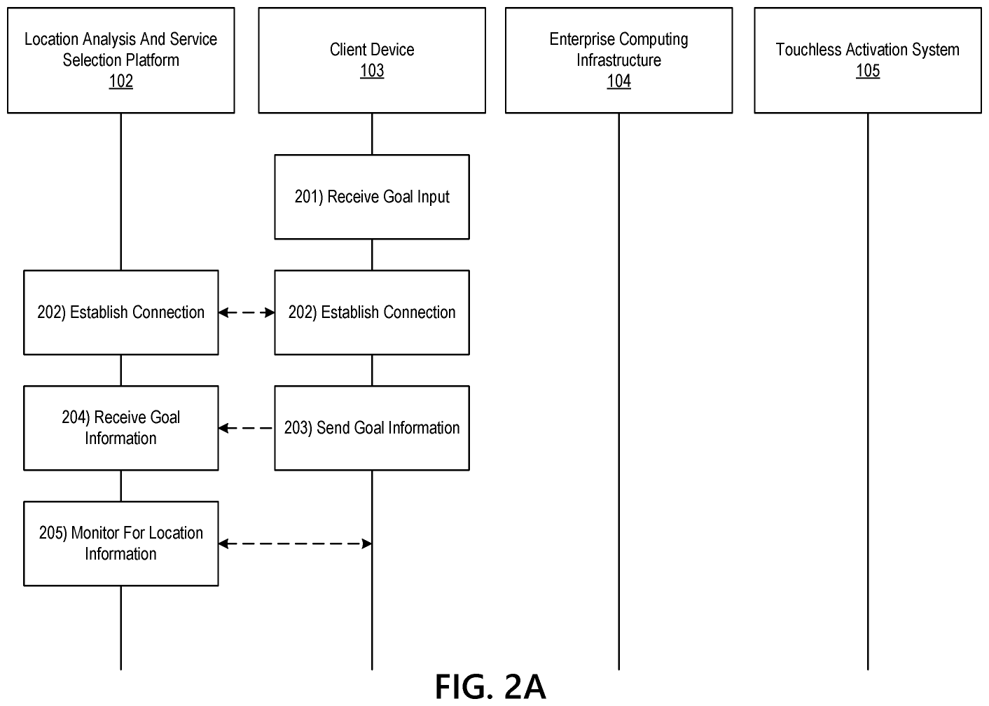

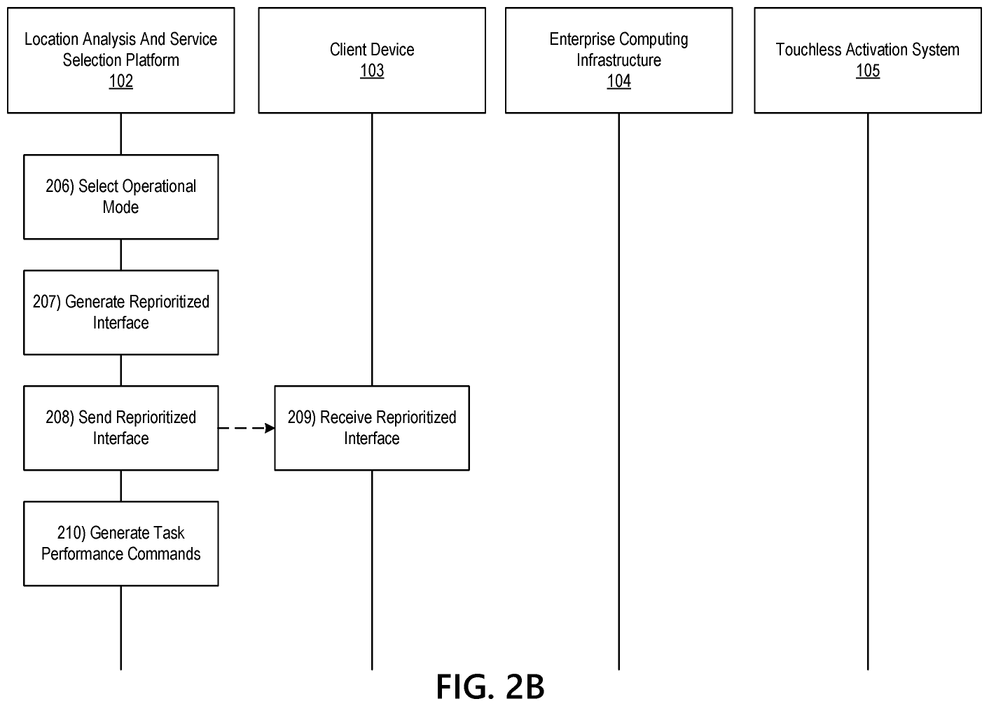

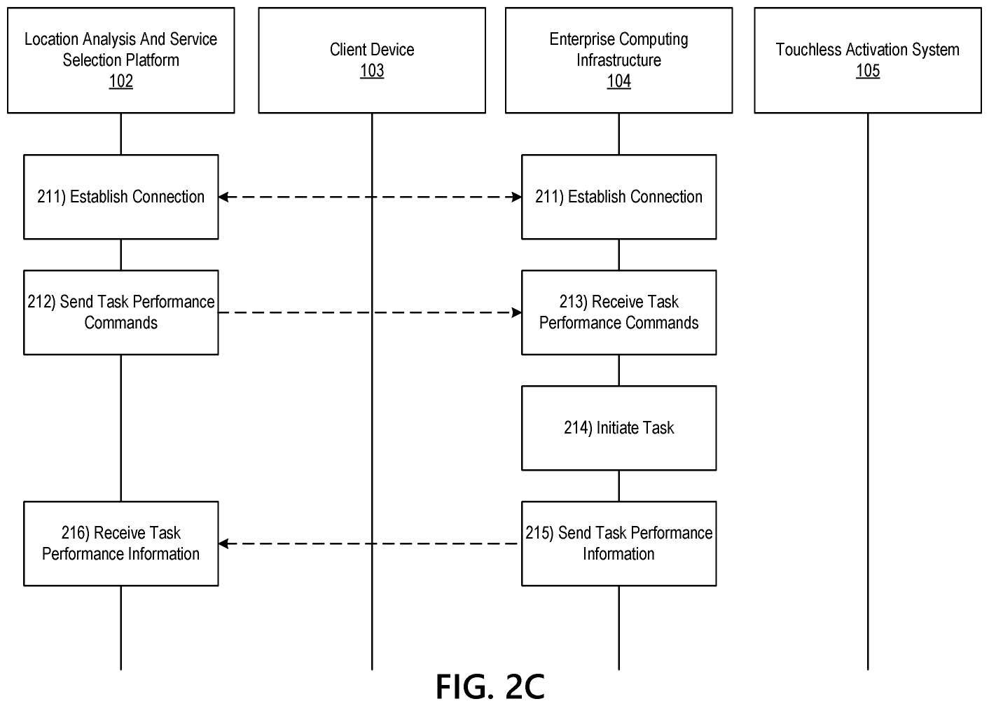

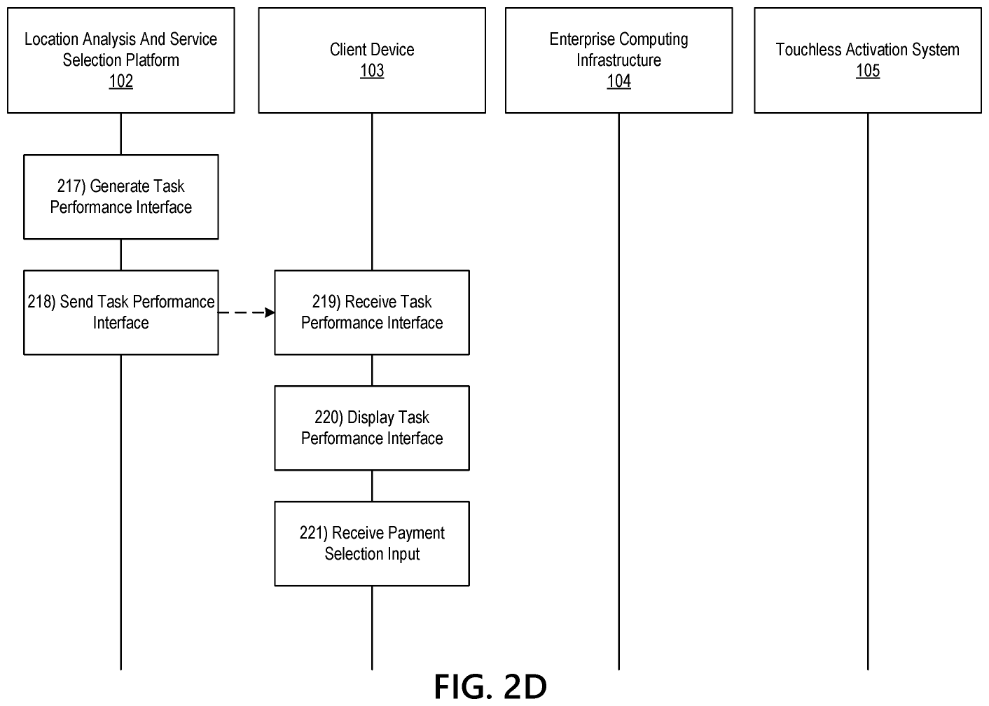

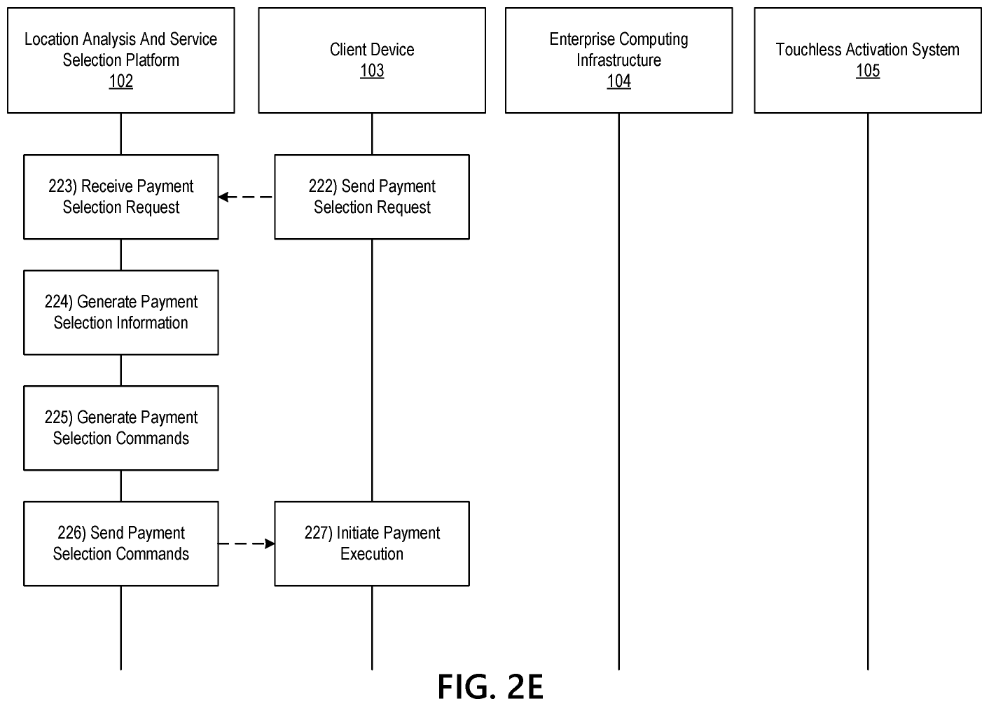

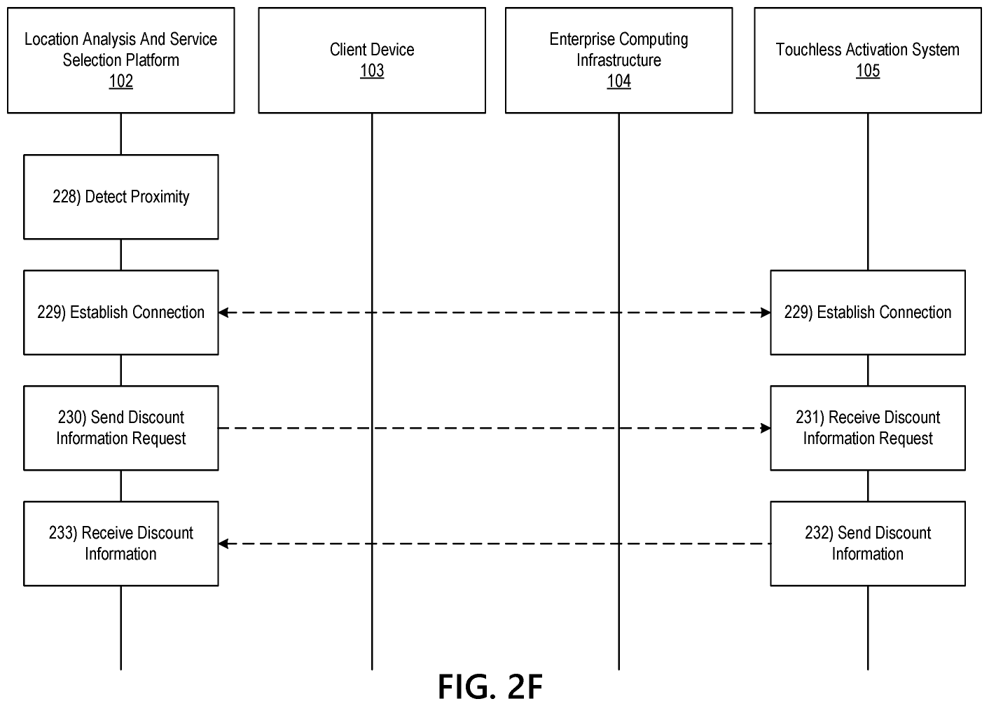

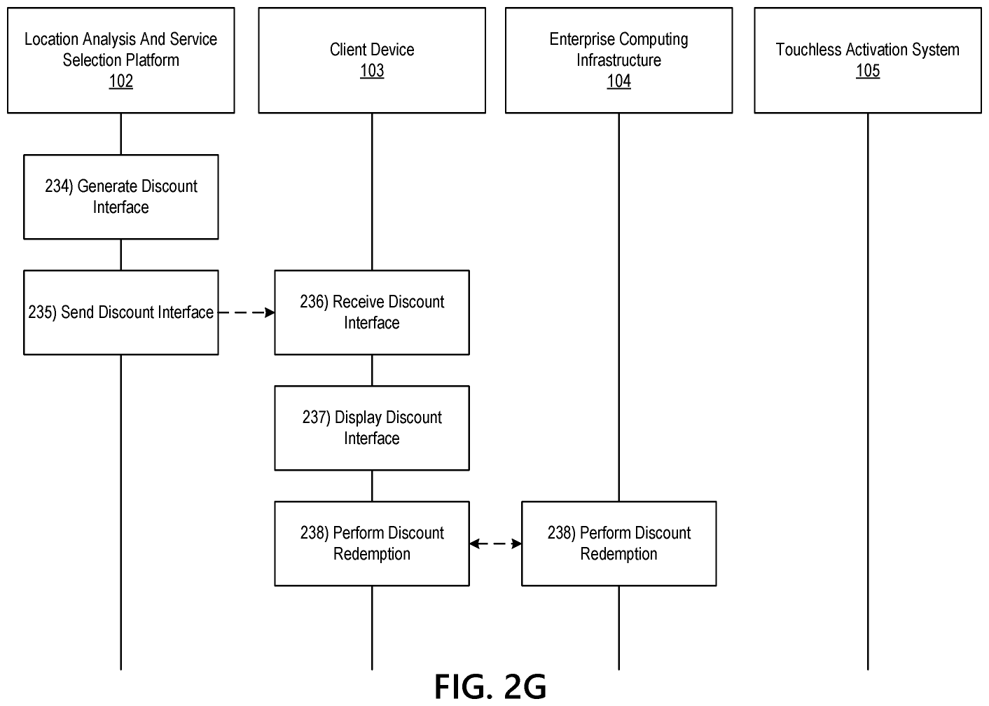

FIGS. 2A-2G depict an illustrative event sequence for location analysis and service selection for dynamic interface generation and event processing in accordance with one or more example embodiments. Referring to FIG. 2A, at step 201, the client device 103 may receive a goal input. For example, the client device 103 may receive a user input indicating one or more goals (e.g., financial goals, travel goals, and/or other goals). Specifically, the client device 103 may receive a user input indicating a goal to travel to a particular destination once enough money is saved. In these examples, the client device 103 may receive the goal input through a mobile application such as a mobile banking application.

At step 202, the client device 103 may establish a connection with the location analysis and service selection platform 102. For example, the client device 103 may establish a first wireless data connection with the location analysis and service selection platform 102 to link the client device 103 to the location analysis and service selection platform 102 (e.g., in preparation for sending goal information). In some instances, the client device 103 may identify whether or not a connection is already established with the location analysis and service selection platform 102. If a connection is established, the client device 103 might not reestablish the connection. If a connection is not yet established with the location analysis and service selection platform 102, the client device 103 may establish the first wireless data connection as described herein.

At step 203, the client device 103 may send, share, or otherwise provide goal information to the location analysis and service selection platform 102. For example, the client device 103 may send, share, or otherwise provide goal information to the location analysis and service selection platform 102 while the first wireless data connection is established.

At step 204, the location analysis and service selection platform 102 may receive or otherwise access the goal information sent at step 203. For example, the location analysis and service selection platform 102 may receive the goal information via the communication interface 113 and while the first wireless data connection is established.

At step 205, the location analysis and service selection platform 102 may monitor the client device 103 to detect a location of the client device 103. For example, the location analysis and service selection platform 102 may be configured to analyze global positioning system (GPS) and/or other location data corresponding to the client device 103 to identify a location of the client device 103. In detecting the location of the client device 103, the location analysis and service selection platform 102 may detect information corresponding to the identified location (e.g., does the location correspond to a home, an office, a business (e.g., financial center, grocery store, restaurant, or other enterprise), a travel destination, and/or other possible locations). For example, in detecting the location of the client device 103, the location analysis and service selection platform 102 may be configured to detect this additional information and/or otherwise correlate a location to a particular property type, business, and/or other information. In some instances, users may provide input indicating a location of their home, office, and/or other locations, and the location analysis and service selection platform 102 may receive and analyze this information to identify a location type.

Referring to FIG. 2B, at step 206, the location analysis and service selection platform 102 may select an operational mode for an application (e.g., a mobile banking or other application) to be displayed at the client device 103. For example, based on the goal information (received at step 204) and/or the location information (detected at step 205), the location analysis and service selection platform 102 may select the operational mode.

In some instances, in selecting the operational mode, the location analysis and service selection platform 102 may identify that the client device 103 is located in a grocery store, and thus may select a shopping mode for the application. In some instances, in selecting the operational mode, the location analysis and service selection platform 102 may identify that the client device 103 is located in a travel destination and that goal information indicated that a user of the client device 103 was planning to take a trip to the corresponding travel destination. Accordingly, in these instances, the location analysis and service selection platform 102 may select a travel model for the application. In some instances, the location analysis and service selection platform 102 may identify that the client device 103 is located at a financial center, and thus may select a financial mode for the application.

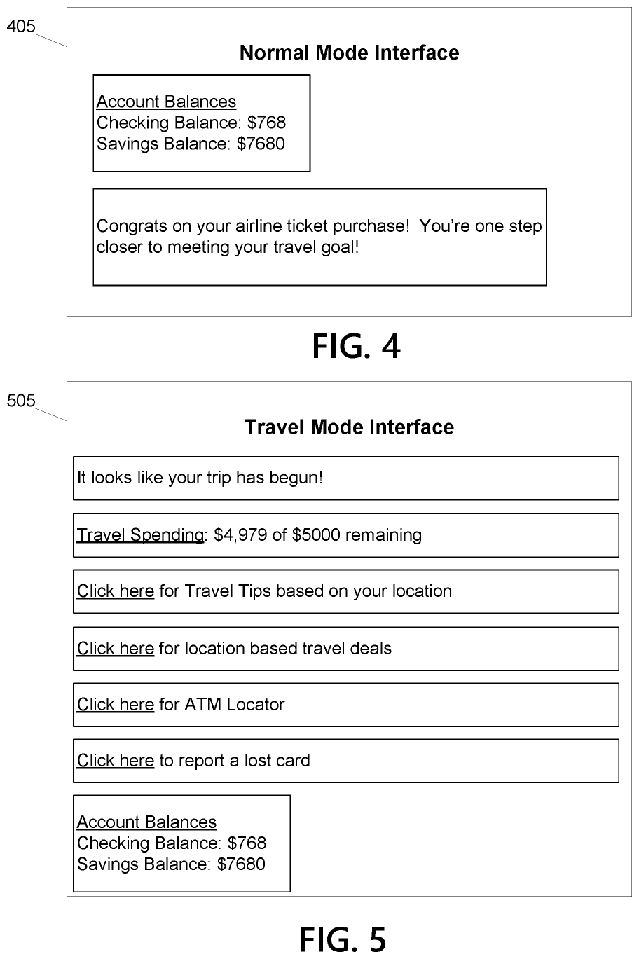

At step 207, the location analysis and service selection platform 102 may generate a reprioritized interface for the application based on the application mode selected at step 206. For example, the location analysis and service selection platform 102 may previously have configured a normal interface corresponding to the mobile application (which may e.g., be similar to graphical user interface 405, which is shown in FIG. 4), which may contain financial information such as account balances and/or other notifications. In generating the reprioritized interface, the location analysis and service selection platform 102 may modify the normal interface to include information selected based on the operational mode selected at step 206 and/or goal information received at step 204. For example, in instances where the shopping mode is selected by the location analysis and service selection platform 102, the location analysis and service selection platform 102 may generate a reprioritized interface that includes a grocery budget, available bank-provided offers and coupons, a payment method offering the most rewards, and/or other shopping specific information.

In instances where the travel mode is selected by the location analysis and service selection platform 102, the location analysis and service selection platform 102 may generate a reprioritized interface similar to graphical user interface 505, which is shown in FIG. 5. For example, the location analysis and service selection platform 102 may generate a reprioritized interface indicating goals (which may be reprioritized for display based on the selected mode and the location information) and/or third-party content (e.g., profiles, reviews, and/or other travel information), available bank-provided offers and coupons, automated teller machine (ATM) locations, a travel budget, travel tips, lost card options, and/or other travel specific information).

In instances where the financial center mode is selected, the location analysis and service selection platform 102 may generate a reprioritized interface that includes location-specific information (e.g., hours, wait time, associate availability, and/or other financial center information), provides functions specific to a financial center (e.g., appointment check-in, authentication, and/or other functions), and/or provides other financial center specific information.

At step 208, the location analysis and service selection platform 102 may send, share, or otherwise provide the reprioritized interface, generated at step 207, to the client device 103. For example, the location analysis and service selection platform 102 may send the reprioritized interface via the communication interface 113 and while the first wireless data connection is established. In some instances, the location analysis and service selection platform 102 may generate and send, along with the reprioritized interface, one or more commands directing the client device 103 to display the reprioritized interface, which may cause the client device 103 to display the reprioritized interface.

At step 209, the client device 103 may receive or otherwise access the reprioritized interface sent at step 208. For example, the client device 103 may receive the reprioritized interface while the first wireless data connection is established. In some instances, the client device 103 may receive, along with the reprioritized interface, one or more commands directing the client device 103 to display the reprioritized interface, which may cause the client device 103 to display the reprioritized interface. In some instances, in displaying the reprioritized interface, the client device 103 may display a graphical user interface similar to graphical user interface 505, which is shown in FIG. 5.

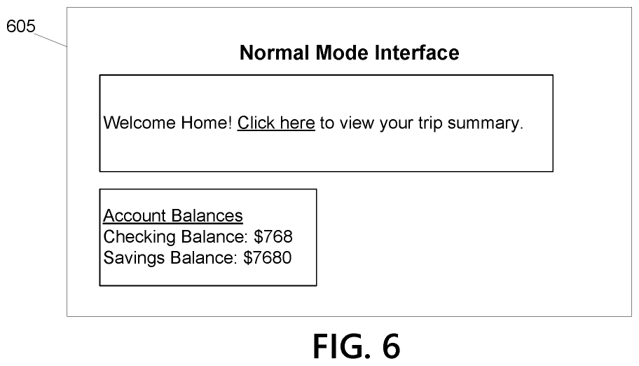

In some instances, once the location analysis and service selection platform 102 determines that the selected mode may be exited, the location analysis and service selection platform 102 may cause the client device to revert to the normal interface. For example, the location analysis and service selection platform 102 may cause the client device 103 to display a graphical user interface similar to graphical user interface 605, which is shown in FIG. 6.

At step 210, the location analysis and service selection platform 102 may generate one or more commands directing an enterprise computing infrastructure 104 to perform one or more tasks. For example, the location analysis and service selection platform 102 may generate one or more commands directing the enterprise computing infrastructure 104 to determine customized deals or offers, lock a credit card, provide foreign transaction assistance, locate an ATM, provide travel tips, provide wait times and/or availability at a financial center, perform an appointment check in, highlight a particular financial center to go to, and/or perform one or more other tasks. With regard to the appointment check in, in some instances, the location analysis and service selection platform may detect, based on the location information, that the client device 103 is within a predetermined proximity of a financial center, and may perform an automated check in for the user or cause the client device 103 to display an alert prompting the user for a selection of an automated check in. In some instances, the location analysis and service selection platform 102 may generate the one or more commands directing the enterprise computing infrastructure 104 to perform one or more tasks based on the location information, goal information, and/or user input received from the client device 103 (which may, e.g., have been received in the application at the normal or reprioritized interface).

Referring to FIG. 2C, at step 211, the location analysis and service selection platform 102 may establish a connection with the enterprise computing infrastructure 104. For example, the location analysis platform 102 may establish a second wireless data connection to link the location analysis and service selection platform 102 with the enterprise computing infrastructure 104 (e.g., for the purpose of sending the one or more commands directing the enterprise computing infrastructure 104 to perform one or more tasks). In some instances, the location analysis and service selection platform 102 may identify whether or not a connection is already established with the enterprise computing infrastructure 104. If a connection is already established with the enterprise computing infrastructure 104, the location analysis and service selection platform 102 might not re-establish the connection. If a connection is not yet established with the enterprise computing infrastructure 104, the location analysis and service selection platform 102 may establish the connection as described herein.

At step 212, the location analysis and service selection platform 102 may send, share, or otherwise provide the one or more commands directing the enterprise computing infrastructure 104 to perform the one or more tasks to the enterprise computing infrastructure 104. For example, the location analysis and service selection platform 102 may send the one or more commands directing the enterprise computing infrastructure 104 to perform the one or more tasks to the enterprise computing infrastructure 104 via the communication interface 113 and while the second wireless data connection is established.

At step 213, the enterprise computing infrastructure 104 may receive or otherwise access the one or more commands directing the enterprise computing infrastructure 104 to perform one or more tasks. For example, the enterprise computing infrastructure 104 may receive the one or more commands directing the enterprise computing infrastructure 104 to perform one or more tasks while the second wireless data connection is established.

At step 214, based on or in response to the one or more commands directing the enterprise computing infrastructure 104 to perform one or more tasks, the enterprise computing infrastructure 104 may initiate the one or more tasks. For example, the enterprise computing infrastructure 104 may determine customized deals or offers, lock a credit card, provide foreign transaction assistance, locate an ATM, provide travel tips, provide wait times and/or availability at a financial center, perform an appointment check in, highlight a particular financial center to go to, and/or perform one or more other tasks.

At step 215, the enterprise computing infrastructure 104 may send, share, or otherwise provide task performance information to the location analysis and service selection platform 102 indicating that the one or more tasks have been performed. For example, the enterprise computing infrastructure 104 may send task performance information to the location analysis and service selection platform 102 while the second wireless data connection is established.

At step 216, the enterprise computing infrastructure 104 may receive or otherwise access the task performance information sent at step 215. For example, the enterprise computing infrastructure 104 may receive the task performance information via the communication interface 113 and while the second wireless data connection is established.

Referring to FIG. 2D, at step 217, the location analysis and service selection platform 102 may generate a task performance interface based on the task performance information received at step 216. For example, the location analysis and service selection platform 102 may generate an interface indicating that the one or more tasks have been performed.

At step 218, the location analysis and service selection platform 102 may send, share, or otherwise provide the task performance interface, generated at step 217 to the client device 103. For example, the location analysis and service selection platform 102 may send the task performance interface to the client device 103 via the communication interface and while the first wireless data connection is established. In some instances, the location analysis and service selection platform 102 may send, along with the task performance interface, one or more commands directing the client device 103 to display the task performance interface.

At step 219, the client device 103 may receive or otherwise access the task performance interface sent at step 218. For example, the client device 103 may receive the task performance interface while the first wireless data connection is established. In some instances, along with the task performance interface, the client device 103 may receive one or more commands directing the client device 103 to display the task performance interface.

At step 220, based on or in response to the one or more commands directing the client device 103 to display the task performance interface, the client device 103 may display the task performance interface. For example, the client device 103 may display an interface indicating that the one or more tasks have been completed.

At step 221, the client device 103 may receive a payment selection input. For example, the client device 103 may receive the payment selection input through an application such as a mobile banking or other application. In some instances, in receiving the payment selection input, the client device 103 may receive an input requesting that a credit card be selected (e.g., from a digital wallet) for payment that provides the largest cash back or points reward based on an organization receiving the corresponding payment (e.g., a grocery store, travel destination, restaurant, and/or other establishment).

Referring to FIG. 2E, at step 222, the client device 103 may send, share, or otherwise provide a payment selection request to the location analysis and service selection platform 102. For example, the client device 103 may send the payment selection request to the location analysis and service selection platform 102 while the first wireless data connection is established.

At step 223, the location analysis and service selection platform 102 may receive or otherwise access the payment selection request sent at step 222. For example, the location analysis and service selection platform 102 may receive the payment selection request via the communication interface 113 and while the first wireless data connection is established.

At step 224, the location analysis and service selection platform 102 may generate payment selection information. For example, based on the goal information (received at step 204), the location information (received at step 205), and/or the operational mode (selected at step 206), the location analysis and service selection platform 102 may select a credit card to be used for payment. In some instances, the location analysis and service selection platform 102 may select a credit card that is stored in a digital wallet corresponding to a mobile banking application operating at the client device 103. In selecting the credit card, the location analysis and service selection platform 102 may identify which of a plurality of stored credit cards may provide the most rewards (e.g., most cash back, most points, or other rewards) if used in a location corresponding to the location information and/or operational mode. For example, an individual may have two credit cards—a 1.5% cash back on everything card and a 3% cash back on groceries/1% back on everything else card. In this example, if the individual is shopping at a grocery store, it may be more advantageous to use the 3% grocery card. Accordingly, in this example, the location analysis and service selection platform 102 may select this card for payment.

For example, to select the credit card, the location analysis and service selection platform 102 may store, for each individual who has registered with the mobile banking application and provided his or her credit card information (e.g., established a digital wallet), benefit information corresponding to each credit card in their digital wallets. For example, the location analysis and service selection platform 102 may store a table that includes columns each corresponding to a particular credit card, and rows corresponding to a type of establishment (e.g., restaurant, grocery store, travel provider, gas station, or other types of businesses). In this example, each row-column intersection may store benefit information for the corresponding credit card when used at the corresponding establishment (e.g., 5% cash back at gas stations, or other promotions). Accordingly, the location analysis and service selection platform 102 may perform a lookup on an establishment corresponding to the location information and/or selected operational mode, identify the largest benefit, and identify the corresponding credit card.

In some instances, the location analysis and service selection platform 102 may incorporate preferred status information for an individual into the payment selection. For example, rewards may be different for an individual with preferred status with a financial institution corresponding to a particular credit card than for an individual who has different status. Accordingly, when compiling the table as described above, the location analysis and service selection platform 102 may take preferred status information for an individual into account.

In some instances, the location analysis and service selection platform 102 may further use the goal information to select a credit card. For example, using the method described above, the location analysis and service selection platform 102 may identify a credit card with the largest cash back promotion and another credit card with the largest points promotion. In this example, the location analysis and service selection platform 102 may identify, based on the goal information, that an individual has a goal of traveling internationally this year. Accordingly, in this example, the location analysis and service selection platform 102 may identify that points may be more valuable to the individual (e.g., because he or she may be able to redeem the points for more travel value than would be attained using the cash back option), and may select the points credit card. After selecting a credit card, the location analysis and service selection platform 102 may generate the payment selection information, which may indicate the selected credit card.

At step 225, the location analysis and service selection platform 102 may generate one or more payment selection commands directing the client device 103 to apply the selected payment method (e.g., the selected credit card from step 224). At step 226, the location analysis and service selection platform 102 may send the one or more payment selection commands to the client device 103 to apply the selected payment method to the client device 103. For example, the location analysis and service selection platform 102 may send the one or more payment selection commands to the client device 103 via the communication interface 113 and while the first wireless data connection is established. In some instances, in sending the one or more payment selection commands to the client device 103 to apply the selected payment method, the location analysis and service selection platform 102 may program and/or configure the client device 103 to apply a particular credit or other electronic payment card from an electronic wallet to use for a particular transaction. In these instances, when the client device 103 performs a touchless payment for the particular transaction, it may apply the particular credit or other electronic payment card as specified by the location analysis and service selection platform 102. For example, the location analysis and service selection platform 102 may configure the client device 103 to apply a first credit card rather than a second credit card.

At step 227, the client device 103 may receive the one or more payment selection commands directing the client device 103 to apply the selected payment method. For example, the client device 103 may receive the one or more payment selection commands directing the client device 103 to apply the selected payment method while the first wireless data connection is established. Based on or in response to the one or more payment selection commands directing the client device 103 to apply the selected payment method, the client device 103 may initiate execution of a payment using the selected payment method.

In some instances, the client device 103 may generate and display a graphical user interface indicating the selected payment method and prompting the user of the client device 103 to use the selected payment method (e.g., display an interface indicating that a first credit card should be used). In other instances, the one or more payment selection commands directing the client device 103 to apply the selected payment method may configure the client device 103 to automatically select the selected payment method from a digital wallet and apply the selected payment (e.g., by placing the client device 103 within a predetermined proximity of a card reader, or another manner that allows the client device 103 to function as the selected payment method). For example, when the client device 103 performs a touchless transaction (e.g., between the client device 103 and a credit card reader), it may automatically apply a particular credit card as specified by the location analysis and service selection platform 102 at step 225.

Referring to FIG. 2F, at step 228, the location analysis and service selection platform 102 may detect that a proximity between the client device 103 and the touchless activation system 105 is below a predetermined threshold distance. At step 229, the location analysis and service selection platform 102 may establish a connection with the touchless activation system 105. For example, the location analysis and service selection platform 102 may establish a third wireless data connection to link the location analysis and service selection platform 102 to the touchless activation system 105 (e.g., in preparation for sending a request for discount information). In some instances, the location analysis and service selection platform 102 may identify whether or not a connection is already established with the touchless activation system 105. If a connection is already established with the touchless activation system 105, the location analysis and service selection platform 102 might not establish the connection. If a connection is not yet established with the touchless activation system 105, the location analysis and service selection platform 102 may establish the third wireless data connection as described herein.

At step 230, the location analysis and service selection platform 102 may send a request for discount information to the touchless activation system 105. For example, the location analysis and service selection platform 102 may send a request for discount information corresponding to establishments within a predetermined distance of the touchless activation system 105 (e.g., restaurants, shops, or other establishments). In some instances, the location analysis and service selection platform 102 may send the request for discount information to the touchless activation system 105 via the communication interface 113 and while the third wireless data connection is established.

At step 231, the touchless activation system 105 may receive the request for discount information sent at step 230. In some instances, the touchless activation system 105 may receive the request for discount information via the communication interface 113 and while the third wireless data connection is established.

At step 232, based on or in response to the request for discount information, the touchless activation system 105 may send discount information to the location analysis and service selection platform 102. For example, the touchless activation system 105 identify promotions, discounts, and/or other offers for establishments located within a predetermined distance of the touchless activation system 105, and may send information to the location analysis and service selection platform 102 indicating these promotions, discounts, and/or other offers. For example, the touchless activation system 105 may send the information to the location analysis and service selection platform 102 while the third wireless data connection is established. In some instances, a user of the client device 103 may be a customer of an enterprise organization (e.g., a financial institution) that corresponds to the touchless activation system 105. In other instances, a user of the client device 103 might not be a customer of the financial institution that corresponds to the touchless activation system 105. In these instances, the touchless activation system 105 may send different discount information based on whether or not the user is a current or prospective customer.

At step 233, the location analysis and service selection platform 102 may receive the discount information sent at step 232. For example, the location analysis and service selection platform 102 may receive the discount information via the communication interface and while the third wireless data connection is established.

Referring to FIG. 2G, at step 234, the location analysis and service selection platform 102 may generate a discount interface based on the discount information received at step 234. For example, the location analysis and service selection platform 102 may generate an interface that indicates a promotion, discount, or other offer based on the discount information or otherwise enables redemption of the promotion, discount, or other offer (e.g., a quick response (QR) code or other redemption method). Additionally or alternatively, the location analysis and service selection platform 102 may generate one or more commands directing the client device 103 to display the discount interface.

At step 235, the location analysis and service selection platform 102 may send the discount interface, generated at step 234, to the client device 103. For example, the location analysis and service selection platform 102 may send the discount interface via the communication interface 113 and while the first wireless data connection is established. In some instances, the location analysis and service selection platform 102 may send, along with the discount interface, the one or more commands directing the client device 103 to display the discount interface. Additionally or alternatively, the location analysis and service selection platform 102 may otherwise activate promotions, discounts, and/or other offers and/or configure the client device 103 to redeem the promotions, discounts, and/or other offers (e.g., using a QR code or other method of redemption).

At step 236, the client device 103 may receive the discount interface sent at step 235. For example, the client device 103 may receive the discount interface while the first wireless data connection is established. In some instances, the client device 103 may receive one or more commands directing the client device 103 to display the discount interface or otherwise configuring the client device 103 to redeem the discounts or other offers.

At step 237, based on or in response to the one or more commands directing the client device 103 to display the discount interface, the client device 103 may display the discount interface (e.g., a QR code or other redemption interface). At step 238, the client device 103 may communicate with the enterprise computing infrastructure 104 to redeem discounts, promotions, and/or other offers corresponding to the discount interface. For example, the enterprise computing infrastructure 104 may scan a QR code displayed at the client device 103 or otherwise communicate with the client device 103 to redeem the discounts, promotions, and/or other offers.

Although the systems and methods described above primarily relate to a shopping mode, travel mode, and financial mode, any number of location based modes may be implemented using one or more of the methods described herein without departing from the scope of the disclosure.

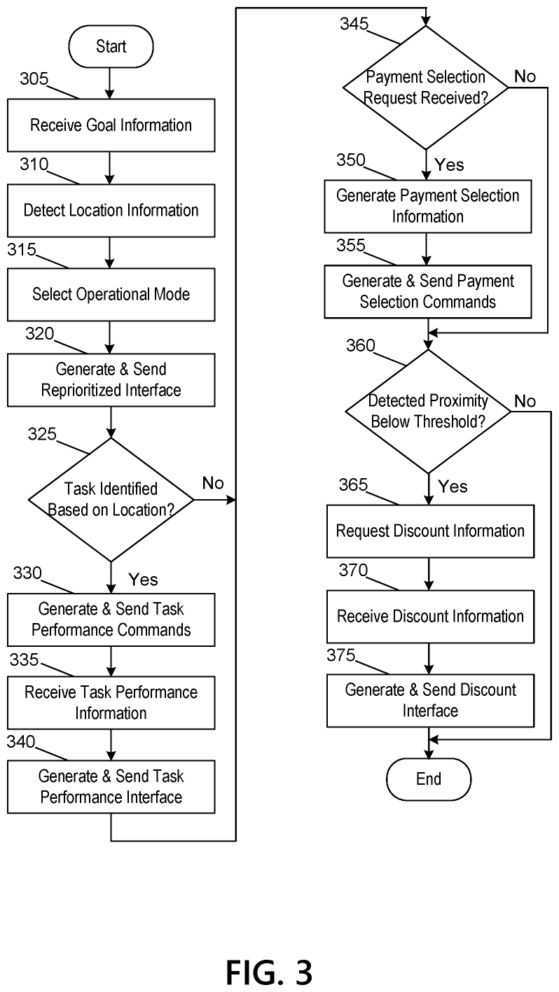

FIG. 3 depicts an illustrative method for location analysis and service selection for dynamic interface generation and event processing in accordance with one or more example embodiments. Referring to FIG. 3, at step 305, a computing platform having at least one processor, a communication interface, and memory may receive goal information from a client device. At step 310, the computing platform may detect location information corresponding to a client device. At step 315, the computing platform may select an operational mode based on the goal information and/or the location information. At step 320, the computing platform may generate and send a reprioritized interface to the client device based on the goal information, location information, and/or operational mode. At step 325, the computing platform may identify whether or not a task is identified to be performed based on the location information and/or user input. If a task is not identified, the computing platform may proceed to step 345. If a task is identified, the computing platform may proceed to step 330.

At step 330, the computing platform may generate and send one or more commands directing an enterprise computing infrastructure to perform the identified task. At step 335, the computing platform may receive task performance information indicating performance of the identified task. At step 340, the computing platform may generate a task performance interface and send the task performance interface to the client device for display. At step 345, the computing platform may identify whether or not a payment selection request is received. If a payment selection request is not received, the computing platform may proceed to step 360. If a payment selection request is received, the computing platform may proceed to step 350.

At step 350, the computing platform may generate payment selection information indicating a selected payment method. At step 355, the computing platform may generate and send one or more commands directing the client device to initiate a payment based on the payment selection information. At step 360, the computing platform may identify whether a proximity between the client device and a touchless activation system is below a predetermined threshold. If the proximity is not below the predetermined threshold, the method may end. If the proximity is below the predetermined threshold, the computing platform may proceed to step 365.

At step 365, the computing platform may request discount information from the touchless activation system. At step 370, the computing platform may receive the discount information from the touchless activation system. At step 375, the computing platform may generate and send a discount interface to the client device.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A computing platform comprising:
at least one processor;
a communication interface communicatively coupled to the at least one processor; and
memory storing computer-readable instructions that, when executed by the at least one processor, cause the computing platform to:
receive goal information indicating one or more user goals;
monitor a user device to detect location information indicating a location of the user device;
select, based on the goal information and the location information, an operational mode for the user device, wherein the operational mode comprises one or more of: a travel mode, a shopping mode, or a financial mode;
generate, based on the selected operational mode, a reprioritized interface for a mobile banking application and one or more commands directing the user device to display the reprioritized interface, wherein the reprioritized interface comprises an updated version of a mobile banking interface that displays information specific to the selected operational mode upon launch of the mobile banking application, and wherein generating the reprioritized interface comprises automatically reprioritizing the one or more user goals for display in the updated version of the mobile banking interface based on the selected operational mode and the location information, wherein reprioritizing the one or more user goals comprises:
based on identifying that the location information indicates a financial institution and the selected operational mode comprises the financial mode, automatically reprioritizing the one or more user goals to display financial goals above travel goals and shopping goals on the mobile banking interface;
send, to the user device, the reprioritized interface and the one or more commands directing the user device to display the reprioritized interface, wherein sending the reprioritized interface and the one or more commands directing the user device to display the reprioritized interface causes the user device to display the reprioritized interface;
receive a payment selection request from a user device;
generate payment selection information based on the selected operational mode and the location information, wherein generating the payment selection information comprises identifying, based on a rewards program associated with each of a plurality of credit cards possessed by a user of the user device, that a first credit card of the user will provide a larger reward if used to perform a transaction at the location than a second credit card of the user;
generate, based on the payment selection information, one or more payment selection commands directing the user device to cause selection of first credit card;
send, to the user device, the one or more payment selection commands directing the user device to cause selection of the first credit card, wherein sending the one or more payment selection commands directing the user device to cause selection of the first credit card causes the user device to select the first credit card, and wherein the one or more payment selection commands directing the user device to cause selection of the first credit card configure the user device to apply the first credit card from an electronic wallet to complete a transaction;
detect that the user device has moved to a second location, different than the location;
receive a second payment selection request from the user device;
generate second payment selection information by identifying, based on the rewards program associated with each of the plurality of credit cards possessed by the user of the user device, that the second credit card of the user will provide a larger reward if used to perform a transaction at the second location than the first credit card of the user;
generate, based on the second payment selection information, one or more second payment selection commands directing the user device to cause selection of the second credit card; and
send, to the user device, the one or more second payment selection commands directing the user device to cause selection of the second credit card, and wherein the one or more second payment selection commands directing the user device to cause selection of the second credit card configure the user device to apply the second credit card from the electronic wallet to complete the transaction at the second location.

2. (canceled)

3. (canceled)

4. The computing platform of claim 1, wherein applying the first credit card from the electronic wallet comprises communicating, by the user device and with a payment card reader, in a touchless manner.

5. The computing platform of claim 1, wherein the one or more payment selection commands directing the user device to cause selection of the first credit card cause the user device to display a graphical user interface indicating that the first credit card should be used.

6. The computing platform of claim 1, wherein the memory stores additional computer-readable instructions that, when executed by the at least one processor, cause the computing platform to:
identify that one or more tasks should be performed;
generate one or more commands directing an enterprise computing infrastructure to initiate performance of the one or more tasks; and
send the one or more commands directing the enterprise computing infrastructure to initiate performance of the one or more tasks to the enterprise computing infrastructure, wherein sending the one or more commands directing the enterprise computing infrastructure to initiate performance of the one or more tasks causes the enterprise computing infrastructure to initiate performance of the one or more tasks.

7. The computing platform of claim 6, wherein identifying that the one or more tasks should be performed is based on one or more of: user input requesting that the one or more tasks be performed, the location information, or the selected operational mode.

8. The computing platform of claim 6, wherein the one or more tasks comprise one or more of: identifying one or more promotional offers, locking a payment card, providing assistance with a foreign transaction, locating an automated teller machine (ATM), replacing a lost payment card, providing travel insights, providing a wait time for a financial center, providing available services for the financial center, indicating a particular financial center to attend, or performing a check in at the financial center.

9. The computing platform of claim 8, wherein performing the check in at the financial center comprises:
detecting, based on the location information, that the user device is within a predetermined proximity of the financial center; and
based on detecting that the user device is within the predetermined proximity of the financial center, performing an automated check in for a user of the user device at the financial center.

10. The computing platform of claim 8, wherein performing the check in at the financial center comprises:
detecting, based on the location information, that the user device is within a predetermined proximity of the financial center; and
based on detecting that the user device is within the predetermined proximity of the financial center, causing the user device to display a check in alert, wherein selection of the check in alert on the user device causes performance of an automated check in for a user of the user device at the financial center.

11. The computing platform of claim 1, wherein the one or more user goals are reprioritized for display in the updated version of the mobile banking interface based on the selected operational mode and the location information.

12. The computing platform of claim 1, wherein the updated version of the mobile banking interface is displayed while the mobile banking interface is operating in the selected operational mode, and wherein the mobile banking interface is restored to an original state once the selected operational mode is exited.

13. A method comprising:
at a computing platform comprising at least one processor, a communication interface, and memory:
receiving goal information indicating one or more user goals;
monitoring a user device to detect location information indicating a location of the user device;
selecting, based on the goal information and the location information, an operational mode for the user device, wherein the operational mode comprises one or more of: a travel mode, a shopping mode, or a financial mode;
generating, based on the selected operational mode, a reprioritized interface for a mobile banking application and one or more commands directing the user device to display the reprioritized interface, wherein the reprioritized interface comprises an updated version of a mobile banking interface that displays information specific to the selected operational mode upon launch of the mobile banking application, and wherein generating the reprioritized interface comprises automatically reprioritizing the one or more user goals for display in the updated version of the mobile banking interface based on the selected operational mode and the location information, wherein reprioritizing the one or more user goals comprises:
based on identifying that the location information indicates a financial institution and the selected operational mode comprises the financial mode, automatically reprioritizing the one or more user goals to display financial goals above travel goals and shopping goals on the mobile banking interface;
sending, to the user device, the reprioritized interface and the one or more commands directing the user device to display the reprioritized interface, wherein sending the reprioritized interface and the one or more commands directing the user device to display the reprioritized interface causes the user device to display the reprioritized interface;
receiving a payment selection request from a user device;
generating payment selection information based on the selected operational mode and the location information, where generating the payment selection information comprises identifying, based on a rewards program associated with each of a plurality of credit cards possessed by a user of the user device, a first credit card that will provide a larger reward if used to perform a transaction at the location than a second credit card of the user;
generating, based on the payment selection information, one or more payment selection commands directing the user device to cause selection of the first credit card;
sending, to the user device, the one or more payment selection commands directing the user device to cause selection of the first credit card, wherein sending the one or more payment selection commands directing the user device to cause selection of the first credit card causes the user device to select the first credit card, and wherein the one or more payment selection commands directing the user device to cause selection of the first credit card configure the user device to apply the first credit card from an electronic wallet to complete a transaction;
detecting that the user device has moved to a second location, different than the location;
receiving a second payment selection request from the user device;
generating second payment selection information by identifying, based on the rewards program associated with each of the plurality of credit cards possessed by the user of the user device, that the second credit card of the user will provide a larger reward if used to perform a transaction at the second location than the first credit card of the user;
generating, based on the second payment selection information, one or more second payment selection commands directing the user device to cause selection of the second credit card; and
sending, to the user device, the one or more second payment selection commands directing the user device to cause selection of the second credit card, and wherein the one or more second payment selection commands directing the user device to cause selection of the second credit card configure the user device to apply the second credit card from the electronic wallet to complete the transaction at the second location.

14. (canceled)

15. (canceled)

16. The method of claim 13, wherein applying the one of the first credit card from the electronic wallet comprises communicating, by the user device and with a payment card reader, in a touchless manner.

17. The method of claim 13, wherein the one or more payment selection commands directing the user device to cause selection of the first credit card cause the user device to display a graphical user interface indicating that the first credit card should be used.

18. The method of claim 13, further comprising:
identifying that one or more tasks should be performed;
generating one or more commands directing an enterprise computing infrastructure to initiate performance of the one or more tasks; and
sending the one or more commands directing the enterprise computing infrastructure to initiate performance of the one or more tasks to the enterprise computing infrastructure, wherein sending the one or more commands directing the enterprise computing infrastructure to initiate performance of the one or more tasks causes the enterprise computing infrastructure to initiate performance of the one or more tasks.

19. The method of claim 18, wherein identifying that the one or more tasks should be performed is based on one or more of: user input requesting that the one or more tasks be performed, the location information, or the selected operational mode.

20. One or more non-transitory computer-readable media storing instructions that, when executed by a computing platform comprising at least one processor, a communication interface, and memory, cause the computing platform to:
receive goal information indicating one or more user goals;
monitor a user device to detect location information indicating a location of the user device;
select, based on the goal information and the location information, an operational mode for the user device, wherein the operational mode comprises one or more of: a travel mode, a shopping mode, or a financial mode;
generate, based on the selected operational mode, a reprioritized interface for a mobile banking application and one or more commands directing the user device to display the reprioritized interface, wherein the reprioritized interface comprises an updated version of a mobile banking interface that displays information specific to the selected operational mode upon launch of the mobile banking application, and wherein generating the reprioritized interface comprises automatically reprioritizing the one or more user goals for display in the updated version of the mobile banking interface based on the selected operational mode and the location information, wherein reprioritizing the one or more user goals comprises:
based on identifying that the location information indicates a financial institution and the selected operational mode comprises the financial mode, automatically reprioritizing the one or more user goals to display financial goals above travel goals and shopping goals on the mobile banking interface;
send, to the user device, the reprioritized interface and the one or more commands directing the user device to display the reprioritized interface, wherein sending the reprioritized interface and the one or more commands directing the user device to display the reprioritized interface causes the user device to display the reprioritized interface;
receive a payment selection request from a user device;
generate payment selection information based on the selected operational mode and the location information, where generating the payment selection information comprises identifying, based on a rewards program associated with each of a plurality of credit cards possessed by a user of the user device, that a first credit card of the user will provide a larger reward if used to perform a transaction at the location than a second credit card of the user;
generate, based on the payment selection information, one or more payment selection commands directing the user device to cause selection of the first credit card;
send, to the user device, the one or more payment selection commands directing the user device to cause selection of the first credit card, wherein sending the one or more payment selection commands directing the user device to cause selection of the first credit card causes the user device to select the first credit card, and wherein the one or more payment selection commands directing the user device to cause selection of the first credit card configure the user device to apply the first credit card from an electronic wallet to complete a transaction;
detecting that the user device has moved to a second location, different than the location;
receiving a second payment selection request from the user device;
generating second payment selection information by identifying, based on the rewards program associated with each of the plurality of credit cards possessed by the user of the user device, that the second credit card of the user will provide a larger reward if used to perform a transaction at the second location than the first credit card of the user;
generating, based on the second payment selection information, one or more second payment selection commands directing the user device to cause selection of the second credit card; and
sending, to the user device, the one or more second payment selection commands directing the user device to cause selection of the second credit card, and wherein the one or more second payment selection commands directing the user device to cause selection of the second credit card configure the user device to apply the second credit card from the electronic wallet to complete the transaction at the second location.

21. The computing platform of claim 1, wherein generating the payment selection information further comprises generating, based on the one or more user goals, the payment selection information, wherein generating the payment selection information based on the one or more user goals comprises:
identifying that the second credit card is associated with a non-travel reward and at least the first credit card is associated with a travel reward, wherein:
the non-travel reward comprises a first number of redeemable points and the travel reward comprises a second number of redeemable points, wherein the first number is larger than the second number,
the non-travel reward is not redeemable towards the one or more user goals, wherein the one or more user goals includes a travel goal, and
the travel reward is redeemable towards with the travel goal; and
identifying, based on identifying that the non-travel reward is not redeemable towards the travel goal and that travel reward is redeemable towards the travel goal, that the first credit card should be selected.

22. The method of claim 13, wherein generating the payment selection information further comprises generating, based on the one or more user goals, the payment selection information, wherein generating the payment selection information based on the one or more user goals comprises:
identifying that the second credit card is associated with a non-travel reward and the first credit card is associated with a travel reward, wherein:
the non-travel reward comprises a first number of redeemable points and the travel reward comprises a second number of redeemable points, wherein the first number is larger than the second number,
the non-travel reward is not redeemable towards the one or more user goals, wherein the one or more user goals includes a travel goal, and
the travel reward is redeemable towards the travel goal; and
identifying, based on identifying that the non-travel reward is not redeemable towards the travel goal and that travel reward is redeemable towards the travel goal, that the first credit card should be selected.

23. The one or more non-transitory computer-readable media of claim 20, wherein generating the payment selection information further comprises generating, based on the one or more user goals, the payment selection information, wherein generating the payment selection information based on the one or more user goals comprises:
identifying that the second credit card is associated with a non-travel reward and the first credit card is associated with a travel reward, wherein:
the non-travel reward comprises a first number of redeemable points and the travel reward comprises a second number of redeemable points, wherein the first number is larger than the second number,
the non-travel reward is not redeemable towards the one or more user goals, wherein the one or more user goals includes a travel goal, and
the travel reward is redeemable towards the travel goal; and
identifying, based on identifying that the non-travel reward is not redeemable towards the travel goal and that travel reward is redeemable towards the travel goal, that the first credit card should be selected.

24. (canceled)

25. The method of claim 18, wherein the one or more tasks comprise one or more of: identifying one or more promotional offers, locking a payment card, providing assistance with a foreign transaction, locating an automated teller machine (ATM), replacing a lost payment card, providing travel insights, providing a wait time for a financial center, providing available services for the financial center, indicating a particular financial center to attend, or performing a check in at the financial center.
